(19) United States
(12) Patent Application Publication
(10) Pub. No.: US 2021/0137311 A1
(43) Pub. Date: May 13, 2021

(54) ARTIFICIAL INTELLIGENCE DEVICE AND OPERATING METHOD THEREOF

(71) Applicant: LG Electronics Inc., Seoul (KR)

(72) Inventors: Seungah CHAE, Seoul (KR); Kyoungup PARK, Seoul (KR)

(21) Appl. No.: 16/715,836

(22) Filed: Dec. 16, 2019

(30) Foreign Application Priority Data
Nov. 8, 2019 (KR) 10-2019-0142564

(51) Int. Cl. A47J 36/32; G06N 3/08; A47J 36/24; G06K 9/62; G06K 9/46

(52) U.S. Cl. CPC A47J 36/321; G06N 3/08; A47J 36/2483; G06K 9/6227; G06K 2209/17; G06K 9/6256; G06K 9/6263; G06K 9/4652; G06K 9/628

(57) ABSTRACT

According to an embodiment, an AI device includes: a cooking unit configured to cook a food by applying heat; a memory configured to store a doneness class classification model for determining a level of a doneness class of a food; a camera configured to capture the food; and a processor configured to determine a level of a doneness class from an image of the captured food by using the doneness class classification model, to determine whether the determined level of the doneness class is equal to a level of a user preference class, and, if the determined level of the doneness class is equal to the level of the user preference class as a result of determining, to control the cooking unit to finish the cooking of the food.

### CROSS-REFERENCE TO RELATED APPLICATIONS

This application claims priority under 35 U.S.C. 119 and 365 to Korean Patent Application No. 10-2019-0142564, filed on 8, Nov., 2019 in the Korean Intellectual Property Office, the disclosure of which is incorporated herein by reference.

### FIELD

The present disclosure relates to an artificial intelligence (AI) device which can cook foods and an operating method thereof.

### BACKGROUND

Ovens are home appliances used for cooking foods.

Cooking times for various foods and food types may be inputted into an oven. A user is allowed to select a cooking time for a specific food by using buttons disposed on a front panel of the oven.

However, when cooking a specific food in the oven, the user may exactly check whether the food is cooked to a desired degree.

The user may check a cooking state of the food by opening the door of the oven in the middle of cooking, which may cause inconvenience.

### SUMMARY

The present disclosure relates to an AI device which grasps a degree of doneness preferred by a user for a specific food, and automatically performs optimum cooking for the corresponding food.

The present disclosure relates to an AI device which receives feedback regarding a degree of doneness preferred by a user for a specific food, and thereafter automatically cooks the corresponding food based on the feedback.

An AI device according to an embodiment of the present disclosure may determine a level of a doneness class from an image of a captured food by using a doneness class classification model, may determine whether the determined level of the doneness class is equal to a level of a user preference class, and, when the determined level of the doneness class is equal to the level of the user preference class as a result of determining, may finish the cooking of the food.

The AI device according to an embodiment of the present disclosure may store a level of a user preference class corresponding to a food, and the level of the user preference class may be set based on user's feedback.

According to an embodiment of the present disclosure, a specific food is automatically cooked without a separate input of a cooking time for the specific food, such that user's convenience can be greatly enhanced.

### BRIEF DESCRIPTION OF THE DRAWINGS

The present disclosure will become more fully understood from the detailed description given herein below and the accompanying drawings, which are given by illustration only, and thus are not limitative of the present disclosure, and wherein:

FIG. 1 illustrates an AI device according to an embodiment of the present disclosure;

FIG. 2 illustrates an AI server according to an embodiment of the present disclosure;

FIG. 3 illustrates an AI system according to an embodiment of the present disclosure;

FIG. 4 illustrates an AI device according to another embodiment of the present disclosure;

FIG. 5 is a flowchart illustrating an operating method of an AI device according to an embodiment of the present disclosure;

FIG. 6 is a view illustrating a doneness class classification model according to an embodiment of the present disclosure;

FIG. 7A is a view illustrating a process of storing a user preference class according to an embodiment of the present disclosure;

FIG. 7B is a view illustrating a preference table showing levels of user preference classes according to foods;

FIG. 8 is a flowchart illustrating an operating method of an AI device according to another embodiment of the present disclosure; and

FIGS. 9 and 10 are views illustrating a notification outputted when cooking of a food is finished according to an embodiment of the present disclosure.

### DETAILED DESCRIPTION

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network may be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer if the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving device may include an actuator or a motor and may perform various physical operations such as moving a robot joint. In addition, a movable robot may include a wheel, a brake, a propeller, and the like in a driving device, and may travel on the ground through the driving device or fly in the air.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined path, and a technology for automatically setting and traveling a path if a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

In this case, the self-driving vehicle may be regarded as a robot having a self-driving function.

### eXtended Reality (XR)

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are illustrated together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing device 140, an output device 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

In this case, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used if an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

In this case, the learning processor 130 may perform AI processing together with the learning processor 240 of the AI server 200.

In this case, the learning processor 130 may include a memory integrated or implemented in the AI device 100. Alternatively, the learning processor 130 may be implemented by using the memory 170, an external memory directly connected to the AI device 100, or a memory held in an external device.

The sensing device 140 may acquire at least one of internal information about the AI device 100, ambient environment information about the AI device 100, and user information by using various sensors.

Examples of the sensors included in the sensing device 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output device 150 may generate an output related to a visual sense, an auditory sense, or a haptic sense.

In this case, the output device 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

If the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. In this case, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 may transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models is implemented in software, one or more instructions that constitute the learning model may be stored in memory 230.

The processor 260 may infer the result value for new input data by using the learning model and may generate a response or a control command based on the inferred result value.

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

In other words, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, In other words, the robot 100a, the self-driving vehicle 100b, the XR device 100c, the smartphone 100d, or the home appliance 100e through the cloud network 10, and may assist at least part of AI processing of the connected AI devices 100a to 100e.

In this case, the AI server 200 may learn the artificial neural network according to the machine learning algorithm instead of the AI devices 100a to 100e, and may directly store the learning model or transmit the learning model to the AI devices 100a to 100e.

In this case, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

### AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the path and the travel plan, may determine the response to user interaction, or may determine the operation.

The robot 100a may use the sensor information acquired from at least one sensor among the lidar, the radar, and the camera so as to determine the travel path and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

In this case, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel path and the travel plan, and may control the driving device such that the robot 100a travels along the determined travel path and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving device based on the control/interaction of the user. In this case, the robot 100a may acquire the intention information of the interaction due to the user's operation or speech utterance, and may determine the response based on the acquired intention information, and may perform the operation.

### AI+Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the path and the travel plan, or may determine the operation.

Like the robot 100a, the self-driving vehicle 100b may use the sensor information acquired from at least one sensor among the lidar, the radar, and the camera so as to determine the travel path and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

In this case, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel path and the travel plan, and may control the driving device such that the self-driving vehicle 100b travels along the determined travel path and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving device based on the control/interaction of the user. In this case, the self-driving vehicle 100b may acquire the intention information of the interaction due to the user's operation or speech utterance, and may determine the response based on the acquired intention information, and may perform the operation.

### AI+XR

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

In this case, the XR device 100c may perform the operation by generating the result by directly using the learning model, but the sensor information may be transmitted to the external device such as the AI server 200 and the generated result may be received to perform the operation.

### AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel path or the travel plan. For example, the robot 100a and the self-driving vehicle 100b having the self-driving function may determine at least one of the travel path or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

In this case, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, if it is determined that the driver is in a drowsy state, the robot 100a may activate the self-driving function of the self-driving vehicle 100b or assist the control of the driving device of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot In other words subjected to control/interaction in an XR image. In this case, the robot 100a may be separated from the XR device 100c and interwork with each other.

If the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user may confirm the XR image corresponding to the time point of the robot 100a interworking remotely through the external device such as the XR device 100c, adjust the self-driving travel path of the robot 100a through interaction, control the operation or driving, or confirm the information about the surrounding object.

### AI+Self-Driving+XR

The self-driving vehicle 100b, to which the AI technology and the XR technology are applied, may be implemented as a mobile robot, a vehicle, an unmanned flying vehicle, or the like.

The self-driving vehicle 100b, to which the XR technology is applied, may refer to a self-driving vehicle having a means for providing an XR image or a self-driving vehicle In other words subjected to control/interaction in an XR image. Particularly, the self-driving vehicle 100b In other words subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

In this case, if the XR object is output to the HUD, at least part of the XR object may be outputted so as to overlap the actual object to which the passenger's gaze is directed. Meanwhile, if the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

If the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

FIG. 4 illustrates an AI device 100 according to an embodiment of the present disclosure.

The redundant repeat of FIG. 1 will be omitted below.

Referring to FIG. 4, the input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information inputted from a user and the mobile terminal 100 may include at least one camera 121 in order for inputting image information.

The camera 121 processes image frames such as a still image or a video acquired by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the mobile terminal 100. Moreover, various noise canceling algorithms for removing noise occurring during the reception of external sound signals may be implemented in the microphone 122.

The user input unit 123 is to receive information from a user and if information is inputted through the user input unit 123, the processor 180 may control an operation of the mobile terminal 100 to correspond to the inputted information.

The user input unit 123 may include a mechanical input means (or a mechanical key, for example, a button, a dome switch, a jog wheel, and a jog switch at the front, back or side of the mobile terminal 100) and a touch type input means. As one example, a touch type input means may include a virtual key, a soft key, or a visual key, which is displayed on a touch screen through software processing or may include a touch key disposed at a portion other than the touch screen.

The output device 150 may include at least one of a display unit 151, a sound output module 152, a haptic module 153, or an optical output module 154.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the mobile terminal 100 and a user, and an output interface between the mobile terminal 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user may feel. A representative example of a haptic effect that the haptic module 153 generates is vibration.

The optical output module 154 outputs a signal for notifying event occurrence by using light of a light source of the mobile terminal 100. An example of an event occurring in the AI device 100 includes message reception, call signal reception, missed calls, alarm, schedule notification, e-mail reception, and information reception through an application.

FIG. 5 is a flowchart illustrating an operating method of an AI device according to an embodiment of the present disclosure.

The AI device 100 of FIG. 5 may be an oven which can cook foods.

The AI device 100 may include a cooking unit (not shown) to cook foods. The cooking unit may cook foods by using the convection principle by which heat is transmitted through air, under control of the processor 180.

To achieve this, the cooking unit may include a coil to generate heat by using electricity, a fan to help convection of the generated heat, and a temperature sensor to control internal temperature.

FIG. 5 illustrates an embodiment which is performed when a cooking time of a food is not set.

The case in which a cooking time of a food is not set may refer to a case in which a user does not input a cooking time into the AI device 100.

The AI device 100 starts cooking a food (S501).

The processor 180 of the AI device 100 may generate heat through the coil according to a command to start cooking of the food, and may drive the fan to cause a convection phenomenon of the generated heat.

The camera 121 of the AI device 100 captures the food (S503).

In an embodiment, the processor 180 may control the camera 121 to periodically capture the food.

The processor 180 may capture the food before cooking or after cooking.

The processor 180 may recognize the food from the captured food image by using an image recognition model.

The image recognition model may be an artificial neural network-based model which is trained by supervised learning through a deep learning algorithm or a machine learning algorithm

The image recognition model may be a model that identifies what the food is from food image data.

The image recognition model may be stored in the memory 170.

The image recognition model may be a model that is trained by the learning processor 130 of the AI device 100.

The processor 180 may acquire identification information identifying the food from the food image by using the image recognition model.

The identification information of the food may be information indicating what kind of food the food is, like the name of the food.

In another embodiment, the processor 180 may identify the food based on a voice command uttered by the user. For example, when the user utters “chicken breast,” the processor 180 may convert the voice command uttered by the user into a text, and may identify the food from the converted text.

The processor 180 of the AI device 100 may determine a doneness class indicating a degree of doneness of the food, from the captured food image, by using a doneness class classification model (S505).

The doneness class classification model may be a model that infers a doneness class indicating how a food is cooked from a food image.

The doneness class classification model may be individually stored in the memory 170 according to a food (or a type of food). That is, there may be a first doneness class classification model corresponding to a first food, and there may be a second doneness class classification model corresponding to a second food.

To achieve this, the process of identifying the food by using the image recognition model may be required after step S503.

The doneness class classification model may be an artificial neural network-based model that is trained by a deep learning algorithm or a machine learning algorithm.

The doneness class classification model may be trained by supervised learning.

A supervised learning method of the doneness class classification model will be described with reference to FIG. 6.

FIG. 6 is a view illustrating the doneness class classification model according to an embodiment of the present disclosure.

Referring to FIG. 6, a learning process of the doneness class classification model 600 is illustrated.

Training data used for supervised learning of the doneness class classification model 600 may be labeled with a doneness class, and the doneness class classification model may be trained by using the labeled training data.

There may be a plurality of doneness classes according to degrees of doneness.

For example, the degrees of doneness may be classified into a first level (very lightly cooked), a second level (lightly cooked), a third level (moderately cooked), a fourth level (moderately-thoroughly cooked), a fifth level (thoroughly cooked), and a sixth level (very thoroughly cooked).

The doneness class classification model 600 may be trained for the purpose of exactly inferring a labeled doneness class from the state of the captured food image.

A cost function of the doneness class classification model 600 may be expressed by a root mean square of differences between labels indicating doneness classes corresponding to respective training data, and doneness classes inferred from the respective training data.

The doneness class classification model 600 may determine model parameters included in the artificial neural network to minimize the cost function through supervised learning.

When an input feature vector is extracted from training food image data and is inputted into the doneness class classification model 600, a result of determining a doneness class may be outputted as an object feature vector. The doneness class classification model 600 may be trained to minimize the cost function corresponding to the difference between the outputted object feature vector and the labeled doneness class.

FIG. 5 will be described again.

After determining the doneness class, the processor 180 of the AI device 100 determines whether a user preference class is stored in the memory 170 (S507).

The user preference class may be a class that reflects a degree of doneness preferred by the user for a specific food.

A level of the user preference class may be one of the plurality of levels that the doneness classes may have.

A process of storing the user preference class will be described with reference to FIGS. 7A and 7B.

FIG. 7A is a view illustrating a process of storing a user preference class according to an embodiment of the present disclosure.

Referring to FIG. 7A, a smartphone 700 of a user is illustrated.

The smartphone 700 may include the components of the AI device 100 shown in FIG. 4.

When cooking of a food is finished, the AI device 100 may capture the food which has been cooked through the camera 121. The AI device 100 may transmit the captured food image to the smartphone 700 of the user.

The processor 180 of the AI device 100 may determine a level of a doneness class from the captured food image by using the doneness class classification model.

The processor 180 of the AI device 100 may transmit the level of the doneness class and the captured food image to the smartphone 700.

The smartphone 700 may display a cooking completion notification 710 including the received food image 711 and the level 713 of the doneness class which are received from the AI device 100.

The user may store the level 713 of the doneness class included in the cooking completion notification 710 as a preference level through the smartphone 700. The smartphone 700 may transmit the level 713 of the user preference class preferred by the user to the AI device 100, and the AI device 100 may store the level 713 of the user preference class in the memory 170.

According to an embodiment of the present disclosure, the level of the user preference class may vary according to a plurality of foods.

FIG. 7B is a view illustrating a preference table showing levels of user preference classes according to foods.

Referring to FIG. 7B, the preference table 730 is illustrated. The preference table 730 may be a table in which levels of doneness classes match a plurality of foods.

For example, a label of a user preference class of chick breast may be 4 (thoroughly cooked), a level of a user preference class of hamburger may be 2 (moderately cooked), a level of a user preference class of fried potato may be 1, a level of a user preference class of dumpling may be 3, and a level of a user preference class of pork belly may be 5.

The reference table 730 may be a table that is generated by receiving user's feedback, and may be stored in the memory 170 of the AI device 100.

The level of the user preference class according to each food, which is included in the reference table 730, may be updated according to user's feedback.

According to another embodiment, when the AI device 100 is provided with the display unit 151, the AI device 100 may display a captured image food and a level of a doneness class of the food on the display 151 after finishing cooking the food.

When a storing command is received from the user, the AI device 100 may store identification information of the corresponding food, the captured image of the corresponding food, and the level of the doneness class of the corresponding food in the memory 170.

FIG. 5 will be described again.

When the user preference class is stored, the processor 180 of the AI device 100 may determine whether the determined doneness class is equal to the user preference class (S509).

That is, the processor 180 may determine whether the level of the determined doneness class of the corresponding food is equal to the level of the user preference class.

The processor 180 may extract the level of the user preference class of the corresponding food stored in the memory 170, and may determine whether the extracted level is equal to the level of the determined doneness class.

When the determined doneness class is equal to the user preference class, the processor 180 of the AI device 100 may finish cooking the food (S511).

That is, when the level of the determined doneness class is equal to the level of the user preference class, the processor 180 may control the cooking unit to finish cooking the food.

When the level of the determined doneness class is equal to the level of the user preference class, the processor 180 may measure a cooking time of the food. That is, the processor 180 may measure the cooking time taken from a time at which cooking of the food starts to a time at which cooking of the food is finished.

The processor 180 may store the measured cooking time in the memory 170. The stored cooking time is a cooking time that is stored when the same type of food is cooked through the AI device 100, and a timer may be automatically set.

On the other hand, when the user preference class is not stored in the memory 170, the processor 180 of the AI device 100 may determine whether the level of the determined doneness class is lower than a level of a default doneness class (S513).

A level of a user preference class for a specific food may not be stored. In this case, the processor 180 may compare the level of the determined doneness class with the level of the default doneness class.

The default doneness class may be a class indicating a medium degree of doneness, but this is merely an example. The default doneness class may vary according to a type of food.

When the level of the determined doneness class is lower than the level of the default doneness class, the processor 180 of the AI device 100 may continue cooking the food (S515).

When it is determined that the level of the determined doneness class is lower than the level of the default doneness class, the processor 180 may determine that there is a need to cook the food more, and may control the cooking unit to continue cooking the food.

The processor 180 may periodically capture the food and may determine a level of a doneness class from the captured food image by using the doneness class classification model. The processor 180 may continue cooking until the level of the doneness class is equal to the level of the default doneness class.

When the level of the determined doneness class is equal to or greater than the level of the default doneness class, the processor 180 of the AI device 100 may finish cooking the food (S511).

According to embodiments of the present disclosure as described above, the food can be automatically cooked according to user's preference for the degree of doneness of the food.

Accordingly, a specific food is automatically cooked without a separate input of a cooking time for the specific food, such that user's convenience can be greatly enhanced.

FIG. 8 is a flowchart illustrating an operating method of an AI device according to another embodiment of the present disclosure.

In particular, FIG. 8 illustrates an embodiment which is performed when a cooking time of a food is set.

The case in which a cooking time of a food is set may be a case in which a cooking time is automatically set based on the cooking time stored in the memory 170 as described above in relation to step S511 of FIG. 5.

In another example, the case in which a cooking time of a food is set may be a case in which setting of a cooking time is received through a user input.

In the embodiment of FIG. 8, a redundant explanation of the same parts as in the embodiment of FIG. 5 is omitted.

The AI device 100 starts cooking a food (S801).

The processor 180 of the AI device 100 determines whether a cooking end time arrives according to the set cooking time (S803).

When the cooking end time arrives, the processor 180 of the AI device 100 captures the food through the camera 121 (S805).

The processor 180 of the AI device 100 determines a doneness class indicating a degree of doneness of the food from the captured food image by using the doneness class classification model (S807).

The doneness class classification model is the same as described above with reference to FIGS. 5 and 6.

The processor 180 of the AI device 100 determines whether the determined doneness class is equal to a user preference class (S809).

In the embodiment of FIG. 8, it is assumed that the level of the user preference class for the corresponding food is pre-stored in the memory 170. That is, the preference table 730 shown in FIG. 7B may be stored in the memory 170.

The processor 180 of the AI device 100 may finish cooking the food when the determined doneness class is equal to the user preference class (S811).

When the level of the determined doneness class is lower than the level of the user preference class (S813), the processor 180 of the AI device 100 may extend the cooking time of the food (S815).

When the level of the determined doneness class is lower than the level of the user preference class, the processor 180 may determine that the cooking of the food is not completed and the food is undercooked, and may extend the cooking time of the food.

The processor 180 may periodically capture the image of the food through the camera 121, and may determine a level of a doneness class from the captured food image by using the doneness class classification model 600.

The processor 180 may extend the cooking time of the food until the level of the determined doneness class is equal to the level of the user preference class.

When the level of the determined doneness class is greater than the level of the user preference class (S813), the processor 180 of the AI device 100 may finish cooking the food (S811).

When the level of the determined doneness class is greater than the level of the user preference class, the processor 180 may determine that the food is excessively cooked and is overcooked, and may control the cooking unit to finish cooking the food.

According to embodiments of the present disclosure described above, even when the cooking time of the food is set, the cooking time may be extended according to a cooking state of the food.

FIGS. 9 and 10 are views illustrating a notification outputted when cooking of a food is completed according to an embodiment of the present disclosure.

Referring to FIG. 9, the AI device 100 may be an oven. When a level of a doneness class of chicken is equal to a level of a user preference class, the oven 100 may output a notification 900 indicating that cooking of the chicken is completed as a voice.

In another example, the oven 100 may transmit, to the smartphone 700 of the user through the communication unit 110, information indicating that cooking of the chicken is completed and an image of the chicken captured in the cooked state. The communication unit 110 may be referred to as a communication interface.

Referring to FIG. 10, the smartphone 700 may display a notification 1000 including a text 1010 indicating that cooking of the chicken is completed, and an image 1030 of chicken, which are received from the oven 100, through the display unit 151.

The user can easily and rapidly check whether the food is cooked to user's preferred degree through the notification 1000.

The present disclosure may also be embodied as computer readable codes on a medium having a program recorded thereon. The computer readable medium is any data storage device that may store data which may be thereafter read by a computer system. Examples of the computer readable medium include HDD (Hard Disk Drive), SSD (Solid State Disk), SDD (Silicon Disk Drive), ROM, RAM, CD-ROM, a magnetic tape, a floppy disk, an optical data storage device, or the like. In addition, the computer may include the processor 180 of the AI device.

What is claimed is:

1. An AI device comprising:
a cooking unit configured to cook a food by applying heat;
a memory configured to store a doneness class classification model for determining a level of a doneness class of a food;
a camera configured to capture the food; and
a processor configured to determine a level of a doneness class from an image of the captured food by using the doneness class classification model, to determine whether the determined level of the doneness class is equal to a level of a user preference class, and, if the determined level of the doneness class is equal to the level of the user preference class as a result of determining, to control the cooking unit to finish the cooking of the food.

2. The AI device of claim 1, wherein the doneness class classification model is an artificial neural network-based model which is trained through a deep learning algorithm or a machine learning algorithm, and
wherein the doneness class classification model is trained through supervised learning.

3. The AI device of claim 2, wherein a training data set used for supervised learning of the doneness class classification model comprises training food image data and a level of a doneness class indicating a degree of doneness labeled to the training food image data.

4. The AI device of claim 1, wherein the memory is configured to store the level of the user preference class corresponding to the food, and
wherein the level of the user preference class is set based on user's feedback.

5. The AI device of claim 1, further comprising a communication interface configured to communicate with an external device,
wherein the processor is configured to transmit information indicating that the cooking of the food is finished, and an image of the food captured when the cooking of the food is finished to the external device through the communication interface.

6. The AI device of claim 1, wherein the memory is configured to store a plurality of doneness class classification models corresponding to a plurality of foods.

7. The AI device of claim 6, wherein the processor is configured to acquire identification information identifying the food from the image of the captured food, and to acquire a doneness class classification model corresponding to the identification information.

8. The AI device of claim 1, wherein, if the cooking of the food is finished, the processor is configured to acquire a cooking time from a time when the cooking of the food starts to a time at which the cooking of the food is finished, and to match the acquired cooking time with identification information of the food and to store in the memory.

9. An operating method of an AI device, the method comprising:
capturing a food which is being cooked;
determining a level of a doneness class from an image of the captured food by using a doneness class classification model for determining a level of a doneness class of a food;
determining whether the determined level of the doneness class is equal to a level of a user preference class; and
if the determined level of the doneness class is equal to the level of the user preference class as a result of determining, finishing the cooking of the food.

10. The method of claim 9, wherein the doneness class classification model is an artificial neural network-based model which is trained through a deep learning algorithm or a machine learning algorithm, and
wherein the doneness class classification model is trained through supervised learning.

11. The method of claim 10, wherein a training data set used for supervised learning of the doneness class classification model comprises training food image data and a level of a doneness class indicating a degree of doneness labeled to the training food image data.

12. The method of claim 9, further comprising storing the level of the user preference class corresponding to the food,
wherein the level of the user preference class is set based on user's feedback.

13. The method of claim 9, further comprising transmitting information indicating that the cooking of the food is finished, and an image of the food captured when the cooking of the food is finished to an external device.

14. The method of claim 9, further comprising storing a plurality of doneness class classification models corresponding to a plurality of foods.

15. The method of claim 14, further comprising:
acquiring identification information identifying the food from the image of the captured food; and
acquiring a doneness class classification model corresponding to the identification information.

16. The method of claim 9, further comprising:
if the cooking of the food is finished, acquiring a cooking time from a time when the cooking of the food starts to a time at which the cooking of the food is finished; and
matching the acquired cooking time with identification information of the food and storing.
